(19) United States
(12) Patent Application Publication
(10) Pub. No.: US 2007/0184781 A1
(43) Pub. Date: Aug. 9, 2007

(54) Protective cover assembly for portable electronic device

(76) Inventor: Scott Huskinson, Logan, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/493,289

(22) Filed: Jul. 26, 2006

Related U.S. Application Data
(60) Provisional application No. 60/752,193, filed on Dec. 20, 2005.

(51) Int. Cl. H04B 1/00

(52) U.S. Cl. 455/42

(57) ABSTRACT

Disclosed is a customizable protective covering for a portable electronic device. The protective covering includes a main sleeve portion which is inserted over the electronic device and which contains apertures therein to allow continued access to portions of the electronic device. A groove is formed around the perimeter of the sleeve portion and a removable band is inserted into groove and acts as a bumper. The bumper may be flush with or offset from the perimeter of the sleeve portion. The combination of the sleeve and bumper is customizable. Further customization is provided with a cling which can be statically adhered to the electronic device. The cling can cover one or more of the portions of the electronic device with ornamental designs. An accessory management system is attached to the sleeve or bumper, around which a cord can be wound and securely maintained.

### CROSS-REFERENCE TO RELATED APPLICATIONS

This application claims priority to, and the benefit of, U.S. Provisional Patent Application, Ser. No. 60/752,193, filed Dec. 20, 2005 and entitled “PROTECTIVE COVER ASSEMBLY FOR PORTABLE ELECTRONIC DEVICE”, which is incorporated herein by reference in its entirety.

### BACKGROUND OF THE INVENTION

1. The Field of the Invention

This invention is in the field of accessories for electronic devices. More particularly, the invention relates to protective covers for multimedia devices which have interchangeable components to provide multiple appearances and functionalities to the protective cover.

2. The Related Technology

As consumers become increasingly technology savvy and as technology continues to progress, consumers' desire for convenient technology that meets various personal needs similarly increases. Accordingly, technology companies are developing greater numbers of portable electronic devices which are convenient and easily transported and which otherwise meet the desires of these consumers.

Numerous examples of such portable electronic devices can currently be found, and for a wide variety of purposes. For example, cellular phones and calculators are exemplary well-known devices that have been available for numerous years for performing specific functions. Increasingly, however, consumers demand expanded capabilities and other devices are now available to meet these demands. For instance, personal digital assistants (PDA), iPods and other portable music and video devices, GPS and other navigational systems, and handheld gaming devices are examples of other portable devices which are commonly being used by consumers, and which were traditionally fixed to a specific location.

While the portability of these devices increases their convenience, the risk of inadvertent damage to the devices is also increased. For example, because these devices are portable, there is a greater likelihood that they will be used outdoors and exposed to the elements, and they also have a greater likelihood of being dropped, misplaced, or damaged in some other way. To account for this increased risk of damage, some protection is needed.

One method of protection is to provide an extra layer on the exterior of the portable device, such that it acts as a cover that can act as a shock absorber for the device, a protective covering, and/or weatherproofing for the device. Covers are additionally being seen as an accessory which acts as a means for expressing the user's individual taste and style. Covers may have a variety of different components, colors, patterns, shapes, sizes, and materials to allow a user to express himself or herself.

One consistent problem, however, is that if a user desires to change the look of a particular cover it often requires purchasing a brand new cover. It would therefore be desirable to have a modular cover that protects the electronic device while also enabling a user to quickly change the look of the cover without requiring purchasing an entirely new cover.

### BRIEF SUMMARY OF THE INVENTION

The present invention relates to accessories for electronic devices and, more particularly, to protective covers for handheld or portable devices which have interchangeable components to provide multiple and customized appearances and functionalities to the protective cover.

The present invention thus relates to a cover assembly that comprises a sleeve portion and a bumper to be placed on the sleeve portion. The bumper is placed on the, sleeve portion for a variety of different reasons. For example, the bumper changes the appearance of the cover assembly sleeve portion. In addition, the bumper and sleeve can individually and separately provide shock resistance for an electronic device covered by the sleeve portion. Thus, the cover assembly provides both aesthetic modularity as well as a functional protection.

In one embodiment, the cover comprises a sleeve configured to cover an electronic device such as a handheld iPod device made by Apple®, comprising a sleeve having a plurality of apertures, one for the display, one for the navigational system, and one or more apertures for ports therein, cords, accessories, and connectors. The apertures are configured to correspond to such portions on the iPod or other device.

The perimeter of the sleeve is configured with a groove therein in order to receive any of a plurality of different bumpers. The groove is configured such that the bumper can be placed thereon, secured thereto, or removed therefrom. In one embodiment, the bumper includes one or more apertures for ports, accessories, cords, or connectors of the electronic device, and which correspond to one or more such apertures in the sleeve and to such portions on the electronic device.

In one embodiment, a cover assembly includes a sleeve and a bumper further combined with a cling that is placed in between the sleeve and the electronic device in order to provide further modularity. The cling may include a transparent region or area which is positioned over the display, and a design region or area which corresponds with the navigational system to allow for further individual customization of the cover assembly.

The bumper and/or sleeve can have a variety of different designs, further enhancing the modularity of the system. For example, in one embodiment the bumper is flexible and has a smooth exterior surface. In another embodiment, the bumper has a rigid exterior surface. In another embodiment the bumper has a textured exterior surface. In another embodiment the bumper has a built-in accessory management system for the ear pieces and/or a corresponding cord.

The holders for the cord may be comprised of a variety of different members. In one embodiment a plurality of rigid, extensions are connected to the sleeve and/or bumper. In another embodiment, an extension is integrally formed with the bumper.

The bumper may further have indicia thereon, cut or molded therein, and may further have a variety of different ornamental features, textures, thicknesses, and the like.

In one embodiment, an outer surface of the bumper is wholly or partially raised with respect to the remainder of the cover such that an additional level of protection is provided for the periphery of the device where the protection is the most needed. Alternatively, the bumper may be substantially flush with the cover, or offset therein, thereby providing a flatter, sleeker, and less bulky appearance. In this manner, a user's ability to easily store the device is enhanced.

As will be appreciated, the materials, patterns, and configurations of the various components of the present invention are varied. In one embodiment, for example, both the sleeve and bumper are comprised of a silicone material. However, a variety of different types of materials may also be employed in other embodiments. Additionally, such materials may be in any of a variety of different colors, patterns, textures, and the like so as to provide a user with the ability to customize the cover assembly and obtain individualized and selected looks.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an electronic device positioned within a protective cover assembly of the present invention, wherein the protective cover assembly comprises a sleeve and a bumper;

FIG. 1B is a perspective view of the sleeve of FIG. 1 on an electronic device;

FIG. 1C is a side view of the protective sleeve of FIG. 1B;

FIG. 1D is a perspective view of the bumper of FIG. 1;

FIG. 2 is a perspective view of an electronic device positioned within a protective cover assembly, wherein the protective cover assembly comprises a sleeve and a bumper, and wherein the bumper is offset from the sleeve;

FIG. 3A is an exploded, perspective view of a protected electronic device assembly comprising an electronic device and a protective cover assembly, according to one embodiment of the present invention, wherein the protective cover assembly comprises a cling, a sleeve, and a bumper.

FIG. 3B is a frontal view of the protected electronic device assembly of FIG. 3A;

FIGS. 4A and 4B, respectively, illustrate frontal and bottom views of a sleeve according to one embodiment of the present invention;

FIGS. 5A and 5B, respectively, illustrate frontal and bottom views of an alternative bumper according to one embodiment of the present invention;

FIGS. 6A and 6B are perspective views of alternative embodiments of a sleeve according to embodiments of the present invention;

FIG. 7A is a frontal view of a protective cover assembly, wherein the protective cover assembly comprises an accessory management and storage system;

FIG. 7B is a side view of the protective cover assembly of FIG. 7A;

FIG. 8 is a back view of an electronic device having a protective cover assembly and belt clip attached thereto; and

FIGS. 9A-9H illustrate cross-sectional views of various embodiments of protective cover assemblies having a sleeve and a bumper connected thereto.

### DETAILED DESCRIPTION OF THE PREFERRED EMBODIMENTS

Reference will now be made to the figures wherein like structures will be provided with like reference designations. It is understood that the drawings are diagrammatic and schematic representations of presently preferred embodiments of the invention, and are not limiting of the present invention nor are they necessarily drawn to scale.

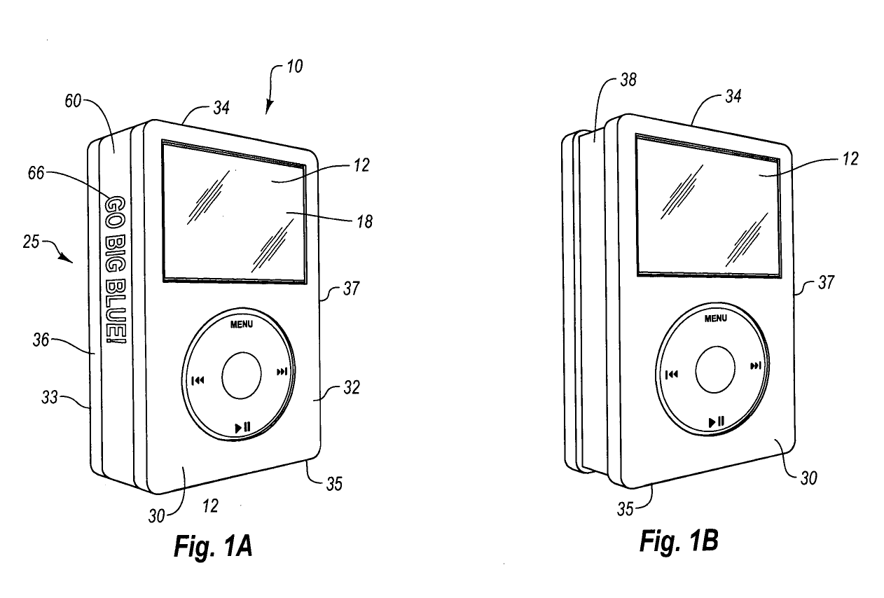

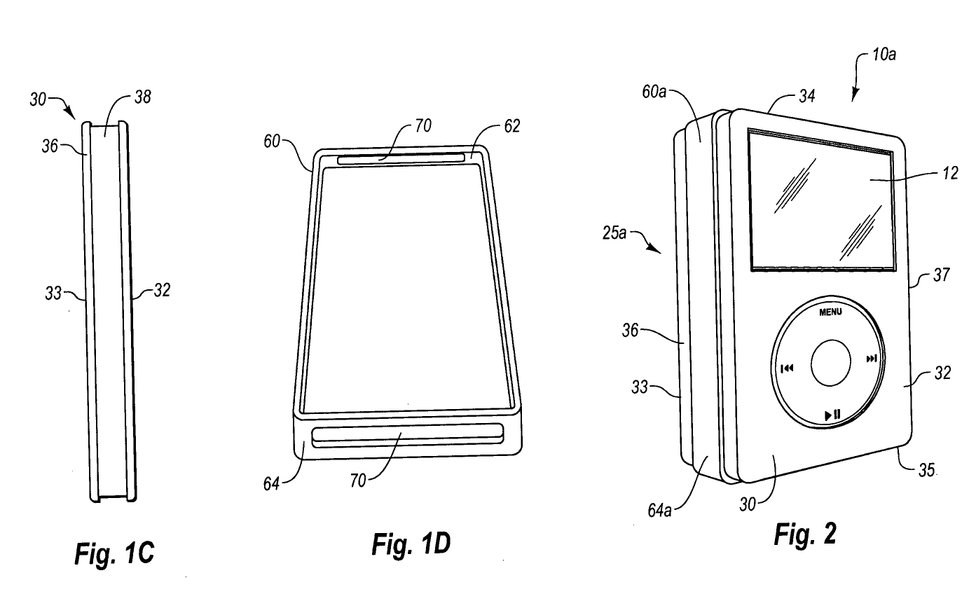

With reference to FIGS. 1A-1D, a protected electronic device assembly 10 is illustrated. In the illustrated embodiment, the protected electronic device assembly 10 includes an electronic device 12 and a protective cover assembly 25. In this embodiment, an exemplary portable electronic device is illustrated which may be used for storing and playing music and/or video. It will be appreciated, however, that the illustrated electronic device is exemplary only, and a variety of devices useful for other functions and purposes are contemplated and are within the scope of the present invention. Accordingly, the terms “portable, handheld electronic device,” “electronic device,” and the like should not be limited to any particular device or function. For instance, the terms may be broadly interpreted to include, for example, among other items, iPods and other music and video or multimedia devices, cellular phones, PDAs, portable DVD players, GPS and navigational systems, handheld gaming devices, calculators, organizers, electronic translators, and a variety of other devices.

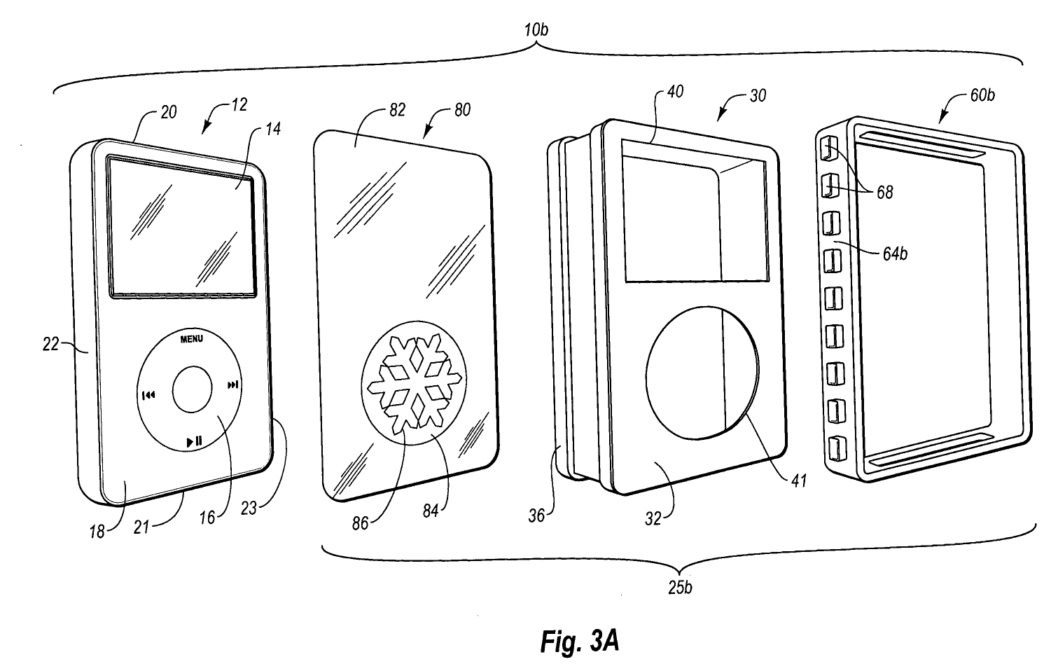

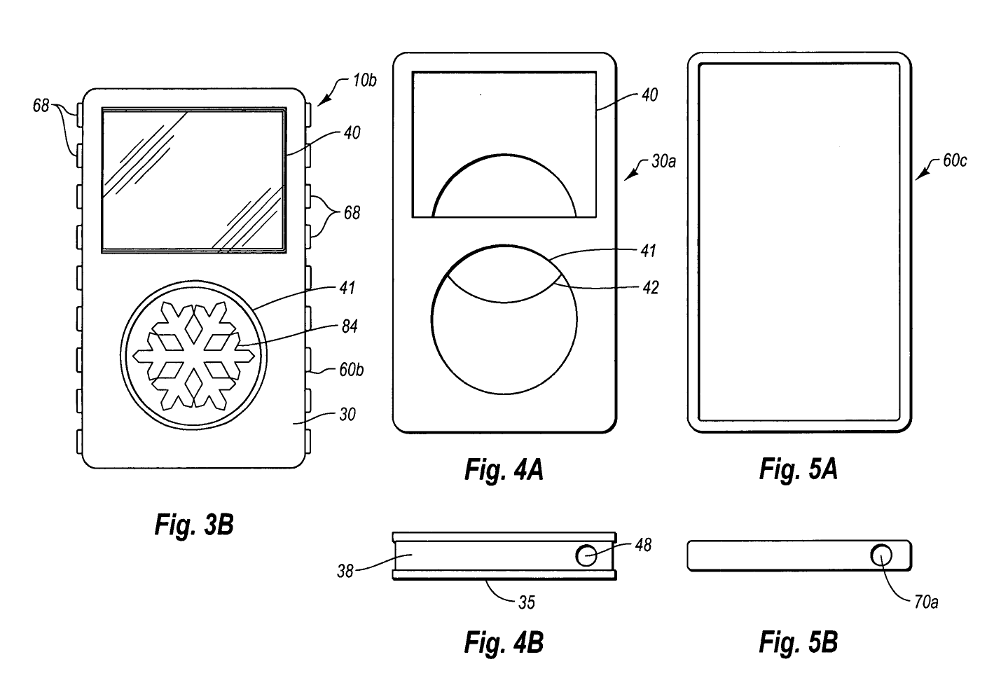

In the embodiment illustrated in FIG. 1A, electronic device 12 is substantially rectangular, e.g. a rectangle having rounded corners. Accordingly, electronic device 12 includes a front side 18 connected to a back side 19 (FIG. 8), by a perimeter. In one embodiment, the perimeter connecting front side 18 to back side 19 is made up of top side 20, bottom side 21, left side 22 and right side 23 (see FIG. 3A). As is further illustrated, protective cover assembly 25 is configured such that the shape of protective cover assembly 25 has a shape and size generally corresponding to the shape and size of electronic device 12. In this embodiment, for example, protective cover assembly 25 comprises a protective sleeve 30 and a bumper 60. As illustrated in FIGS. 1A and 1B, protective sleeve 30 is substantially rectangular, and includes a front side 32, a backside 33, and an outer perimeter defined by sides 34-37, wherein each of sides 32-37 of sleeve 30 correspond to a respective side 18-23 of electronic device 12.

As is further illustrated in FIG. 1A, protective cover assembly 25 includes bumper 60, which is configured to mate with sleeve 30. More particularly, bumper 60 is an endless band which is configured to extend around the perimeter of sleeve 30, such that an interior surface 62 of bumper 60 contacts sides 34-37 of sleeve 30. In one embodiment, the length of the perimeter of bumper 60 is smaller than the length of the perimeter of sleeve 30 and/or groove 38, and bumper 60 is stretched to fit around sleeve 30 and thereby compressibly secures sleeve 30 around electronic device 12.

As illustrated in FIG. 1D, bumper 60 may also have a shape that generally corresponds to the shape of sleeve 30 and electronic device 12. It will be appreciated, however, that this is not necessary, and that in other embodiments, bumper 60 has other shapes and configurations. For instance, and as discussed in more detail hereafter, bumper 60 may comprise a flexible, elastomeric material. Accordingly, the shape and/or size of bumper 60 can be varied as the flexible material is deformed by stretching bumper 60. In this manner, bumper 60 can be of virtually any shape and the shape of bumper 60 can be deformed to correspond to the size and configuration of sleeve 30 and electronic device 12. More particularly, bumper 60 may be an endless band of a rectangular, circular, triangular, or any other shape which enables bumper 60 to have an endless configuration with an opening therethrough.

As illustrated in FIG. 1B, and in additional detail in FIG. 1C, sleeve 30 may also be configured to mate with bumper 60 and/or secure bumper 60 in place. In one embodiment, for example, a groove 38 is an annular groove that extends fully around sides 34-37 of sleeve 30, and is centered between front side 32 and back side 33 of sleeve 30. Groove 38 is adapted to receive bumper 60 therein. In particular, in this embodiment, the width of groove 38 is substantially the same as the width of bumper 60. In this manner interior surface 62 of bumper 60 can be inserted into groove 38, thereby mating against the perimeter of sleeve 30.

Various advantages can be seen by mating bumper 60 with sleeve 30 to form protective cover assembly 25. As will be appreciated, because electronic device 12 is portable, electronic device 12 is also subject to being inadvertently dropped, being exposed to water, sand, dust, or other elements, or to any of a variety of other undesirable conditions. As a consequence of such conditions, electronic device 12 can be damaged and, in some cases, cease working altogether.

When protective cover assembly 25 is installed, however, the effect of such conditions can be avoided or reduced. For instance, in one embodiment, protective sleeve 30 is substantially impermeable, such that it protects against inadvertent exposure of electronic device 12 to water, dirt, dust, and the like. As will be discussed in more detail hereafter, a variety of impermeable materials are contemplated in this regard, including metals, fabrics, and plastics.

Moreover, bumper 60 can similarly provide protection against exposure to the elements. Further, as will be appreciated, when a user inadvertently drops electronic device assembly 10, bumper 60 and/or sleeve 30 can act as shock absorbers and thereby provide added impact resistance. For example, in one embodiment, sleeve 30 and/or bumper 60 are made of a shock absorbent material such as silicone which reduces the effect of an impact on electronic device 12.

Moreover, in embodiments where bumper 60 is positioned around the periphery of sleeve 30 and electronic device 12, bumper 60 can add a further level of impact protection. It will be appreciated that in the event electronic device 12 is dropped or otherwise caused to receive an undesirable impact, the outer edge of electronic device 12, along sides 19-22, can be particularly susceptible to damage. Accordingly, the placement of bumper 60 along the outer edges of electronic device 12 and sleeve 30 can provide an added level of impact resistance.

In this regard, bumper 60, in one embodiment, can be made of the same or a similar material as sleeve 30, e.g. silicon. Additionally, to provide added impact resistance beyond that supplied by sleeve 30 alone, the thickness of bumper 60a exceeds the depth of groove 38, as illustrated in FIG. 2. In this manner, when bumper 60a is inserted into groove 38, an exterior surface 64a of bumper 60a is offset from the outer surface of adjacent portions of sides 34-37 of sleeve 30. In such an embodiment, when an impact would otherwise occur on sides 19-22 of electronic device 12, or sides 34-37 of sleeve 30, bumper 60a can receive and/or absorb the impact before such an impact is received by either sleeve 30 or electronic device 12, and thus added protection is provided thereto.

Another advantage of bumpers 60 and 60a used in connection with sleeve 30 is that sleeve 30 can be tightly secured against electronic device. For example, as noted herein, protective sleeve 30 can be made of any of a variety of materials. In some embodiments, the material is elastomeric and defonnable such that when sleeve 30 is around electronic device 12, such as is shown in FIG. 1A, sleeve 30 can tightly fit around and, accordingly, be securely fastened to electronic device 12. In other embodiments, sleeve 30 is made of materials which are not deformable or which otherwise do not create a tight fit around electronic device 12. In such an embodiment, bumper 60 may, for example, be elastomeric and deformable, such that when bumper 60 is fitted into groove 38, bumper 60 compresses sleeve 30 or otherwise securely fastens sleeve 30 to electronic device 12.

Moreover, bumper 60 is selectively removable such that it provides added customization so as to provide users with the ability to modify protective cover assembly 25 to incorporate desired individualized and selected looks. Whether or not bumper 60 facilitates fastening of sleeve 30 to electronic device 12, bumper 60 can be used to quickly and easily customize protective cover assembly 25 in any way desired by the user. For instance, bumper 60 can be removably secured to sleeve 30 in groove 38. Sleeve 30 and/or bumper 60 can be made in any of a variety of colors, patterns, shapes, textures, configurations, materials, and the like. Accordingly, a large number of combinations of sleeve 30 and bumper 60 can be made, wherein each combination has a unique and customized appearance. In this manner, it will be appreciated that bumper 60 thus acts as a cosmetic band such that when bumper 60 is replaced with a bumper having a different configuration (e.g. appearance, color, texture, thickness, etc.), the overall appearance of protective cover assembly 25 is also changed and customized.

In the embodiments illustrated in FIGS. 1A-1D, the thickness of bumper 60 is substantially equal to the depth of groove 38. Accordingly, when bumper 60 is positioned in groove 38, exterior surface 64 of bumper 60 is about flush with the outermost surface of sides 34-37 of sleeve 30, and substantially seamlessly therewith. In this manner, protective cover assembly 25 has a flat, sleek appearance and configuration such that a user can easily store electronic device assembly 10 in, for example, a pocket or other portion of clothing of the user. It should be appreciated, however, that in other embodiments, such as that illustrated in FIG. 2, bumper 60a and/or groove 38 may have a greater or lesser thickness or depth, respectively, such that exterior surface 64 may not be flush with sides 34-37 but is instead inwardly or outwardly offset therefrom.

Moreover, in the embodiment illustrated in FIG. 1A, bumper 60 includes customized indicia 66, thereby allowing for even greater customization of protective cover assembly 25. Indicia 66 may be formed in any of a variety of manners. For instance, indicia 66 may be debossed (with or without color fill) or embossed in bumper 60. Such debossing or embossing may be produced by, for example, manufacturing a mold from which bumper 60 is thereafter produced. Alternatively, an embossing may be fused thereto or a debossing may be formed or otherwise cut therein (e.g. branding, engraving, milling, waterjet cutting, laser cutting, etc.). In yet another alternative, indicia 66 are formed by screen or transfer printing. While indicia 66 are disclosed herein as being positioned on bumper 60, it will be appreciated that this feature is non-limiting. For example, in other embodiments, indicia, designs, and/or other features are formed on sleeve 30.

As will be appreciated, electronic device 12 may have accessories extending therefrom, or ports, jacks, or connections to allow additional accessories or other electrical or mechanical devices to connect thereto. For instance, where electronic device 12 is a multimedia device such as an iPod manufactured by Apple®, electronic device 12 may have jacks for connecting, among other things, headphones or speakers, a power supply, a computer, and other input or output devices. Accordingly, as is further illustrated in FIG. 1C, bumper 60 has, in some embodiments, one or more apertures 70 formied therein. Corresponding apertures can also be formed within sleeve 30. In this manner, a user can access accessory or other input or output devices without it being necessary to remove protective cover assembly 25.

Now referring to FIGS. 3A and 3B, an alternative embodiment of an electronic device assembly 1Ob is illustrated which includes an electronic device 12 and a protective cover assembly 25b. Protective cover assembly 25b is comprised of sleeve 30 of FIG. 1, and further comprises a cling 80 and an alternate bumper 60b.

As further illustrated, electronic device 12 may have one or more portions thereof which remain accessible through protective cover assembly 25b. For example, electronic device 12 includes a visual output display 14 and a navigational system 16. Visual output display 14 may be used for any of the variety of purposes. For instance, visual output display 14 may be used to display indicia representative of audio content being provided by a speaker or audio output (not shown) of electronic device 12. In still other examples, visual output display 14 provides a user with other visual content such as text, television, video, device or file information, graphics, maps, and the like.

As noted previously, electronic device 12 may also, in some embodiments, include navigational system 16. Navigational system 16 is configured to facilitate use of electronic device 12 by a user. For instance, a multimedia device capable of playing audio and/or video content and files may have navigational system 16 so as to allow a user to select and play one or more multimedia content files (e.g. audio, video, etc.) stored thereon or otherwise accessible thereto. In some embodiments, as a user navigates among various files or options on or accessible through electronic device 12, visual output display 14 displays such options and/or files to a user to facilitate selection by the user through navigational system 16.

As further illustrated in FIGS. 3A and 3B, protective cover assembly 25b is further configured to allow a user to access navigational system 16 and visual output display 14 of electronic device 12 while protective cover assembly 25b is secured thereto. In particular, in the illustrated embodiment, a display aperture 40 is formed within front side 32 of sleeve 30 and synchronized with visual output display 14 of electronic device 12. In this manner, a user can view or otherwise access content provided by electronic device 12 while protective cover assembly 25b is fastened thereto. Further, front side 32 of sleeve 30 includes a navigational aperture 41 formed therein, which corresponds to navigational system 16 of electronic device 12. In this manner, a user can easily access and use navigational system 16 while protective cover assembly 25b is positioned on electronic device 12. In one embodiment, electronic device 12 is inserted into sleeve 30 through display aperture 40 by stretching aperture 40 while device 12 is inserted therethrough.

In the illustrated embodiment, protective cover assembly 25b includes sleeve 30 of FIGS. 1A-1C, a textured bumper 60b, and a cling 80. Cling 80 is configured to protect front side 18 of electronic device 12, while minimizing any disruption to the output provided through visual output display 14 and/or navigational system 16. For instance, in one emibodiment, cling 80 is a thin, light permeable material, e.g. a transparent or a translucent material, e.g. a vinyl material, that statically adheres to electronic device 12 when placed on front side 18 of electronic device 12, under sleeve 30. Cling 80 is sufficiently thin such that the output of visual output display 14 is not significantly affected, while also allowing a user to easily use navigational system 16. The use of cling 80 with electronic device 12 is idesirable for various reasons.

For example, cling 80 can securely and removably adhere to electronic device 12, so as to create a substantially impermeable seal around navigational system 16 and visual output display 14. In this manner, because cling 80 is transparent or translucent, a user can access the content provided through visual output display 14 while cling 80 also reduces the risk that water, sand, dust, and the like will enter front side 18 of electronic device 12 and disrupt operation thereof.

Additionally, visual output display 14 may, in some embodiments, also be an input device such as a touch-sensitive screen. By securing cling 80 to visual output display 14, a user can further protect visual output display 14 from scratching caused by a stylus, from oils in a user's fingers, and other damage.

Further still, and as illustrated in FIG. 3A, in addition to a transparent region 82, which corresponds wholly or partially with visual output display 14 of electronic device 12, cling 80 may further include an ornamental region 84, e.g. an opaque region, having a design therein. In this embodiment, ornamental region 84 corresponds to navigational system 16 of electronic device 12 and provides a customized appearance thereto. In particular, ornamental region 84 covers navigational system 16, such that when installed on electronic device 12, ornamental region 84 provides a removable design aspect which may be further synchronized or combined with sleeve 30 and/or bumper 60b. In some embodiments, ornamental region 84 and/or transparent region 82 further include one or more ornamental designs 86 to allow a user to further customize the appearance and configuration of protective cover assembly 25b. Accordingly, in one embodiment, ornamental region 84 comprises an opaque region having an ornamental design 86 therein. Ornamental region 84 and ornamental design 86 may be imprinted on or formed in cling 80 by any suitable method including, for example, screen or transfer printing, or by four color printing processes.

In some embodiments, cling 80 is synchronized with sleeve 30 and/or bumper 60b. For example, as noted herein, a variety of styles and types of sleeves and bumpers may be combined for a large number of individual combinations. In this manner, sleeve 30 and bumper 60b may be coordinated to achieve a particular style. For instance, a person may select the particular colors of a favorite sports team or college for his or her protective cover assembly 25b. Similarly, cling 30 may be further synchronized with sleeve 30 and/or bumper 60b. For instance, ornamental region 84 may add an additional color or pattern corresponding to the desired style and/or include a logo, picture, design, or other element that corresponds with the other selected components of protective cover assembly 25b.

A method for installing a protective cover assembly 25b will now be described with respect to FIGS. 3A and 3B. It should be appreciated, however, that the following description is illustrative only, and is not limiting of the present invention.

In one implementation, and as discussed previously, a cling 80 is provided which has one or more regions corresponding to features of electronic device 12. In this embodiment, for example, cling 80 includes transparent region 82 which is positioned over visual output display 14 of electronic device 12. Moreover, ornamental region 84 of cling 80 is positioned over navigational system 16, so as to provide a customized appearance thereto, as illustrated in FIG. 3B.

Sleeve 30 is also provided to protect and provide a customized appearance to electronic device 12. In this embodiment, sleeve 30 includes display and navigational apertures 40, 41 which generally correspond to visual output display 14 and navigational system 16 of electronic device 12, respectively.

Installation of sleeve 30 is performed by inserting electronic device 12 therein. This may be performed in a variety of manners. For instance, sleeve 30 may be made of a flexible material. In such a case, a user may temporarily deform the shape of sleeve 30 sufficiently such that electronic device 10 can be inserted through one or more apertures in sleeve 30 (e.g. display aperture 40, navigational aperture 41, or accessory apertures 70).

Optionally, sleeve 30 is further configured to facilitate installation on electronic device 12. For instance, the size of any of the various apertures in any side 32-37 of sleeve 30 may be increased, such that little or no deformation of sleeve 30 is necessary to insert electronic device 12 therein.

As noted previously, sleeve 30 can be of any of a variety of shapes, sizes, and configurations. For instance, in the illustrated embodiment, bumper 60b includes a texture on exterior surface 64b. In particular, in the illustrated embodiment, multiple bumps 68 are formed on exterior surface 64b and extend outwardly therefrom. In this manner, when bumper 60b is positioned on electronic device assembly 1Ob, bumps 68 extends outwardly from exterior surface 64a of bumper 60b and can also extend outwardly from left side 22 and right side 23 of electronic device 12, and left side 36 and right side 37 of sleeve 30. While bumps 68 are described in this embodiment, it will be appreciated that a variety of other textures are contemplated. For instance, in other embodiments, a bumper may include extending depressions, lines, waffles, text, pictures, indicia, and the like, and such texture may extend around each of sides 34-37 of sleeve 30.

As will be appreciated, inasmuch as bumper 60b is removable, a user may customize the appearance of protective cover assembly 25b by removing and/or replacing bumper 60b. Additionally, a textured exterior surface 64b of bumper 60b provides further advantages beyond a customized appearance. For instance, textured exterior surface 64b may be configured to increase friction between a user and protective cover assembly 25b, thereby reducing the risk that the user will inadvertently lose grip of, and drop, protected electronic device assembly 10b. It may also be appreciated that the external surface of sleeve 30 may similarly be textured for additional customization options for a user, as well as for increased friction to enhance the gribability of protected electronic device assembly 10b.

Turning now to FIGS. 4A-4B and 5A-5B, a sleeve 30a, and an alternative bumper 60c are shown. As illustrated and as noted herein, sleeve 30a includes an accessory aperture 48. Accessory aperture 48 is positioned on sleeve 30a so as to allow a user to access an accessory, jack, port, or other input or output device connectable to electronic device 12. Further, accessory aperture 48 can be synchronized with one or more accessory apertures 70a in bumper 60c, such that a user can access a corresponding accessory or port on electronic device 12 through both bumper 60c and sleeve 30a.

As is further illustrated, sleeve 30a further includes display aperture 40, and navigational aperture 41. As noted previously, display aperture 40 can be synchronized with visual output display 14 of electronic device 12 to provide a user access to visual content on visual output display 14 while a protective cover assembly is installed on the corresponding electronic device 12. Similarly, navigational aperture 41 can be synchronized with a corresponding navigational system 16 on electronic device 12.

Also illustrated in FIG. 4A and FIG. 8, a rear aperture 42 is formed in back side 33 of sleeves 30a and 30c, respectively. As will be appreciated, particularly in light of the discussion herein, rear aperture 42 is configured to provide a user with access to features or accessories accessible through back side 19 of electronic device 12. For instance, in one embodiment, a belt clip 52 (illustrated in FIG. 8) is secured to back side 19 of electronic device 12. To allow continued use of belt clip 52 while sleeve 30a or 30c is fastened to electronic device 12, belt clip 52 can be inserted through rear aperture 42. Alternatively, belt clip 52 can be fastened to electronic device 12 after sleeve 30a, 30c is fastened thereon. In still other alternatives, belt clip 52 is attached to sleeve 30a or sleeve 30c. For example, a threaded fastener made of metal, plastic, or another material may be molded into sleeve 30a or 30c, which mates with a corresponding threaded fastener on the belt clip. In yet another embodiment, the belt clip may be integrally formed with sleeve 30a, 30c, or otherwise fastened thereto.

In light of the discussion herein, it will be appreciated that the materials of which the various components of the present invention may be comprised are varied. By way of example and not limitation, both the sleeve and the bumper of the present invention can be comprised of the same material, such as an elastomeric, deformable material. In this manner, and as discussed herein, the sleeve and/or the bumper can act as shock absorbers, and a user can temporarily deform one or more apertures on sleeve 30a so as to insert electronic device 12 therein.

In one embodiment, the elastomeric, deformable material is a silicone material. Exemplary silicon materials may be one hundred percent high grade silicone, as well as other grades of silicone and silicone blends. For instance, rubber silicone and latex silicone are also contemplated by the present invention. It will be appreciated that the materials should not, however, be limited to silicone materials. In one embodiment, for example, material used for sleeves 30-30a and/or bumpers 60-60c include any of a-variety of different elastomeric materials and can, in one embodiment, include anything that is moldable and is at least partially deformable. In this manner, sleeves 30-30a can be deformed sufficiently to fit around electronic device 12, and bumpers 60-60c can be deformed sufficiently to position a bumper 60-60c with respect to a respective sleeve 30-30a such that a sleeve 30-30a fits securely around an electronic device 12 and within the corresponding bumper.

While bumpers 60-60c and sleeves 30-30a can be made of the same materials, it should also be appreciated, that bumpers 60-60c can be made of a different material than sleeve 30-30a. For instance, bumper 60-60c may be made of a rigid or semi-rigid material that snaps into place within a groove 58 of a respective sleeve 30-30a, or which otherwise is secured thereto, and which provides additional protection to the impact areas of electronic device 12. For instance, bumper 60-60c may be made of polyvinyl chloride (PVC), aluminum, titanium, graphite composite, or other suitable metal, plastic, or composite that can provide a customized appearance to a protective cover assembly or which provides protection to electronic device 12.

Moreover, a variety of other types of materials may also be employed in other embodiments of sleeve 30-30a and/or bumper 60-60c. For instance, materials such as leather, metals, vinyl, fabric, straps, reflective materials, chainmail, and the like are contemplated for use in the present invention. Any such materials may also have a variety of properties or be in any of a variety of different colors, patterns, textures, and the like so as to provide a user with additional options for creating an individualized and selected look and function for the cover assembly on electronic device 12. By way of example and not limitation, a harder material may be used where increased protection is desirable. Additionally, reflective or glow-in-the-dark materials can facilitate use of a protective cover assembly as a reflector. The bumper and/or sleeve may comprise such a reflective material, for example. This feature is particularly useful when the user is, for example, jogging or running at night as a user wearing the assembly can thereby alert vehicles or other joggers of the user's presence and location.

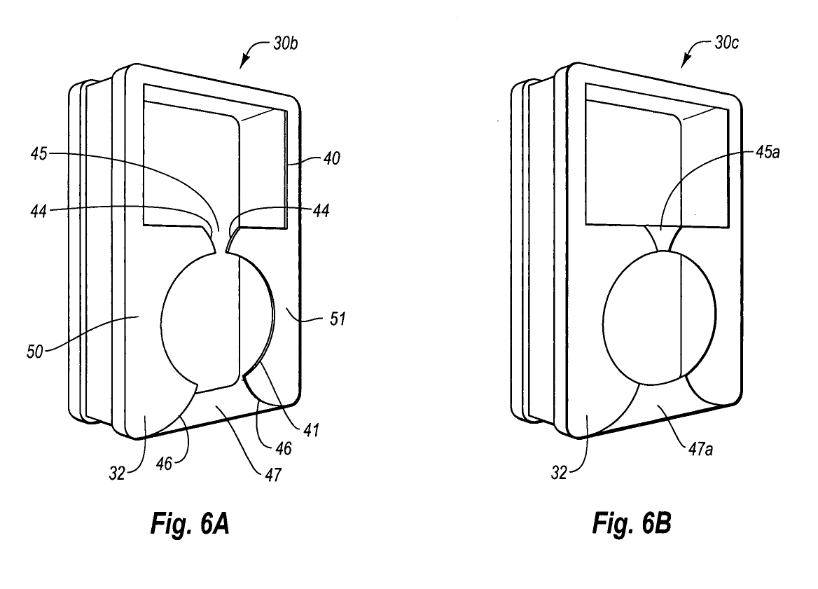

In yet another embodiment, such as is illustrated in FIG. 6A, a sleeve 30b is configured to facilitate installation of sleeve 30b on electronic device 12 by increasing the ease in deforming sleeve 30b.

In particular, in the illustrated embodiment of FIG. 6, wall lines 46 define an optional upper channel 45 connecting navigational aperture 41 to display aperture 40, thus forming left lobe 50 and right lobe 51. Left lobe 50 and right lobe 51 are, in one embodiment, at least partially foldable, such that left lobe 50 and right lobe 51 can be bent or folded, and can extend outwardly from sleeve 30b when bent. Thus, when left lobe 50 and right lobe 51 are bent outwardly, sleeve 30b is deformed such that a larger aperture is created for insertion of electronic device 12.

Front side 32 of sleeve 30b can optionally include one or more additional channels to further facilitate deformation of sleeve 30b and thereby facilitate insertion of electronic device 12. For instance, in the illustrated embodiment, a lower channel 47 is defined by wall lines 46, extending fully between navigational aperture 41 and bottom side 35 of sleeve 30 for added ease in installing sleeve. 30b on electronic device 12. Optionally, lower channel 47 may connect navigational aperture 41 to one or more accessory apertures in bottom side 35 of sleeve 30. It will be appreciated, particularly in light of the teachings herein, that channels 45 and 47 are optional and can provide both design and functional aspects. For instance, in some embodiments, channels 45 and 47 extend fully through the thickness of front 32 of sleeve 30. In other embodiments, channel 45a and/or 47a extend only partially through the thickness, as illustrated with respect to FIG. 6B, in the which channels 45a and 47a extend only partially through the thickness of front 32 of sleeve 30c to facilitate deformation of sleeve 30c and thereby facilitate insertion of electronic device 12. In yet other embodiments, the portions 45a, 47a of sleeve 30care replaced by raised surfaces which provide an ornamental design to sleeve 30c.

Upon securing sleeve 30b to electronic device 12, a bumper such as bumper 60 of FIG. 1A may thereafter be fastened to sleeve 12. In this manner, protected electronic device assembly 10b is formed, as illustrated in FIG. 3B, with an electronic device 12 and a protective cover assembly 25b secured thereto.

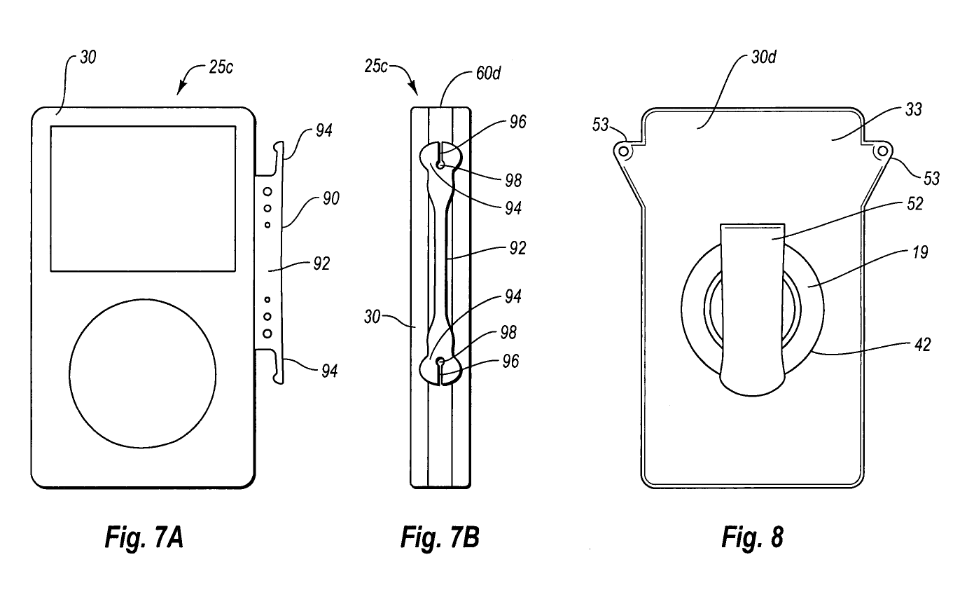

Referring now to FIGS. 7A and 7B, yet another embodiment of a protective cover assembly 25c is illustrated, which includes a sleeve 30, bumper 60d, and an accessory management system 90. In the illustrated embodiment, accessory management system 90 is configured to conveniently store accessories usable with electronic device 12. For instance, exemplary accessories may include, by way of example and not limitation, earphones, USB or firewire cables, power supply cables, and the like that can be wrapped around system 90.

In this embodiment, accessory management system 90 includes a medial portion 92 extending outwardly from bumper 60d. Attached to, and extending in opposite directions from medial portion 92 are two extension members 94. As illustrated in FIG. 7B, extension members 94 are, in one embodiment, generally rounded and pear-shaped, such that they widen as the distance. from medial portion 92 increases. It will be appreciated that no particular shape is required and, in other embodiments, extension members 94 may be of other shapes and configurations including, for example, triangular shaped. Extension members 94 serve, in one embodiment, to retain a cord wrapped on medial portion 92 in place, thus, extension members 94 and/or medial portion 92 are configured to secure accessories in a stored position.

In the embodiment shown, each of extension members 94 includes a slit 96 in communication with a cavity 98. The combination of slit 96 and cavity 98 allows an accessory to be maintained in the stored position. For example, the managed accessory may be earphones (not shown) usable with electronic device 12. A cord attached to the earphones may be wrapped around medial portion 92, while the earphones are inserted through slit 96 and into cavity 98 for storage.

Thus, to store the earphones, a user may wrap a cord around medial portion 92, and the wrapped cord and/or earphones can then being held in place by extension members 94. In particular, when a substantial portion of the cord is wrapped around medial portion 92, the earphones and the immediately adjacent portions of the cord, may be secured by extension members 94. For example, the width of slits 96 may be less than the width of the cord portion adjacent an earphone. Accordingly, to secure the earphone therein, extension member 96 may be temporarily deformed and expanded such that the user can pass the cord therethrough to be received into larger cavity 98. Thereafter, slit 96 is returned to its normal size, such that the cord cannot pass therethrough, until a user desires to selectively release the earphones. The earphones may also include a post or other feature which can be compressibly or otherwise secured in cavity 98. It should be appreciated, however, that the foregoing description is not limiting of the present invention. For instance, in another alternative, the cord is compressible and is compressed as a user presses the cord through slit 96.

Accessory management system 90 can be connected to protective cover assembly 25c in any of a variety of manners. For instance, in one embodiment, accessory management system 90 extends from bumper 60d, e.g. by being integrally formed with bumper 60d and being formed of the same or a different material. In another embodiment, bumper 60d and optionally sleeve 30 include apertures to allow accessory management system to extend therethrough. This may be useful where, for example, accessory management system 90 is permanently or removably secured to sleeve 30 or electronic device 12. Accordingly, in one embodiment, accessory management system 90 is a rigid or semi-rigid material which is separate from electronic device 12, sleeve 30, and bumper 60d and which is inserted under bumper 60d and/or sleeve 30 and extends therethrough for use in managing one or more accessories of electronic device 12. Thus, accessory management system 90 may be coupled to bumper 60d or sleeve 30 or to electronic device 12, or may be separate therefrom.

Although the illustrated embodiment illustrates an accessory management system 90 of a unitary construction extending from bumper 60d, it will be appreciated that these features are non-limiting. For example, it is contemplated that accessory management system 90 may include two or more components such as, for example, two extension members unconnected by a medial portion. Alternatively, accessory management system 90 may be retractable into bumper 60d, sleeve 30, and/or electronic device 12.

In light of the teachings herein, a variety of additional features can be incorporated into the present invention, including both design and functional elements. For example, as previously discussed, one or more textures (e.g. bumps, waffles, lines, channels, embossings, debossings; raised surfaces, depressed surfaces, etc.) can be incorporated on sleeve 30, bumper 60, accessory management system 90, cling 80, or other components of assembly 10.

Further, and as illustrated in FIG. 8, one or more protrusions 53 may extend from sleeve 30d or bumper 60. For example, in this embodiment, protrusions 53 have a hole extending therethrough. In this manner, one or more of protrusions 53 may receive a cord, chain, cable, string, strap, lanyard, and the like. A user may, thus extend the cord or other similar device through one or more of protrusions 53 and extend the cord around his or her neck. Accordingly, a user can transport the protected electronic device assembly in a location that can easily and conveniently be accessed, without the need to remove the assembly from a pocket or carry the assembly in his or her hands. In this manner, protrusions 53, both individually and collectively, can act as a transport system or lanyard holder for a protective cover assembly.

Protrusions 53 may also be replaced by one or more apertures in sleeve 30d, such that the cord or other device can extend at least partially through the interior of sleeve 30d and holes within sleeve 30d act as a transport system. Similarly, protrusions 53 may be of a variety of other configurations. For instance, protrusions 53 may be configured as loops to receive a Velcro strap or other device for securement of sleeve 30d to an arm, leg, waist, belt loop, backpack, or in some other way to a user's body, clothing, accessory, and the like. In some embodiments, accessory management system 90 may also be attached to or otherwise formed in the cord, strap, or other device which engages protrusions 53 or sleeve 30d.

As discussed previously, one feature of the present invention is the modularity of the protective cover assembly allows a large number of combinations such that a user can personalize and customize appearances and functionalities. Accordingly, it will be appreciated, particularly in light of the teachings herein, that for a protective cover assembly that includes a sleeve and a bumper, varying the width, height, and configuration of the band which acts as the bumper can add further modularity by increasing the options for available appearances and functionality.

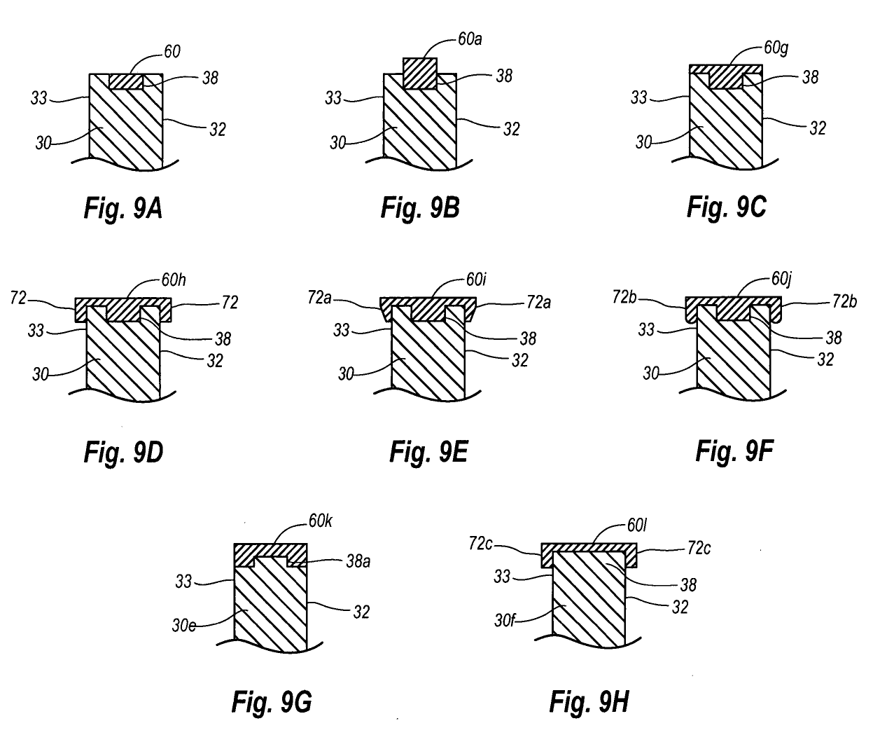

For example, as illustrated in FIGS. 9A-9H, numerous alternatives configurations of a bumper and sleeve are contemplated, according to alternative embodiments of the present invention. As illustrated in FIGS. 9A-9F, for example, an embodiment is illustrated in which a groove 38 is formed in cover, between front side 32 and back side 33. In FIG. 9A, an exemplary embodiment is illustrated in which bumper 60 is positioned fully within groove 38, as shown in FIG. 1. In this manner, bumper 60 fits within sleeve 30 and is substantially seamless with respect to adjacent portions of sleeve 30.

In light of the teachings herein, it will be appreciated that in other embodiments, such as those in FIGS. 9B-9F, bumpers 60f-60j may be outwardly offset, in whole or in part, with respect to sleeve 30. In FIG. 9B, for example, the thickness of bumper 60f is greater than the depth of groove 38, while a width of bumper 60f is approximately equal the width of groove 38. Accordingly, the exterior surface of bumper 60f is outwardly offset with respect to the exterior of sleeve 30. Additionally, as illustrated in FIGS. 9C-9F, a width of bumper 60g-60j may exceed the width of groove 38, and/or be offset from front side 32 or back side 33 of cover 30. In FIG. 9C, for example, the width of bumper 60g is about equal to the width of sleeve 30, and is substantially seamless with front side 32 and back side 33. In this manner, when viewed from the side, a user sees only bumper 60g. The wider configuration of bumper 60g is particularly desirable for a variety of reasons. For instance, if indicia 66 are formed on bumper 60g, the increased width allows larger indicia to be placed thereon, for increased visibility. In addition, the increased width allows indicia to more easily be placed or formed thereon, thus decreasing manufacturing costs.

In FIGS. 9D-9F, various additional embodiments are illustrated in which a bumper 60h-60j is offset from one or more of front side 32 and back side 33 of sleeve 30. For instance, in the illustrated embodiments, the width of bumper 60h-60j is greater than the width of sleeve 30 and is centered thereon. Accordingly, as illustrated in FIG. 9D, bumper 60h is outwardly offset from both front side 32 and back side 33 of sleeve 30, and includes oz overhangs 72 which extend therefrom.

In the embodiments illustrated in FIGS. 9C-9F, bumpers 60g-60j are generally T-shaped. Accordingly, a vertical post portion is positioned within groove 38, and a substantially horizontal portion extends along a side of sleeve 30. In some embodiments, overhangs 72-72b partially cover front side 32 and/or back side 33. One feature of this embodiment is that overhangs 72, which partially cover sides 32-33 of sleeve 30, further secure bumper 60h-60j to sleeve 30, as well as add an additional design element thereto.

As illustrated in FIGS. 9D-9F, overhangs are contemplated in any of a variety of configurations. For instance, overhangs 72 have ends which are substantially squared-off. In contrast, as illustrated in FIG. 9E, the ends of overhangs 72a are tapered and, in this embodiment, taper toward sleeve 30 when bumper 60i is installed thereon. In another embodiment, such as that illustrated in 9F, overhangs 72b have rounded ends.

As will be appreciated, although the described embodiments illustrate an overhang on extending from and partially covering front side 32 and back side 33 of sleeve 30, these feature are not necessary. For instance, overhangs may be included which extend outwardly from sleeve 30, without covering any portion of front side 32 and/or back side 33. Alternatively, an overhang may be included so as to cover only one of front side 32 or back side 33, while the width of such a bumper may be either less or greater than the width of sleeve 30.

In still other embodiments, such a those illustrated in FIGS. 9G and 9H, a bumper 60k-60lis connected to sleeve 30e, 30f, without a corresponding groove 38. For instance, in the embodiment illustrated in FIG. 9G, sleeve 30e includes a lip 38a which is fitted inside a corresponding groove positioned within bumper 60k. In light of the disclosure herein, it will be appreciated that such a configuration may be combined with any other features described herein, including those illustrated in FIGS. 9A-9F. In addition, yet another embodiment is illustrated in FIG. 9H, in which the side surface of sleeve 30f is substantially smooth. In this embodiment, for example, bumper 60l includes overhangs 72c, which facilitate securement of bumper 60l to sleeve 30f. It will be appreciated, however, that overhangs 72c are not necessary and that in still other embodiments, a bumper is compressibly secured to a sleeve without overhangs, grooves, lips, and the like.

In light of the teachings herein, it will be appreciated that the foregoing embodiments are illustrative only and that other embodiments are within the scope of the present invention. For instance, in other embodiments, the thickness of a bumper may be less than the depth of a corresponding groove in a sleeve, such that an exterior surface of the bumper is inwardly offset with respect to adjacent portions of the sleeve.

The present invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A cover assembly for use on a portable, handheld electronic device, the cover assembly comprising:
a sleeve configured to be mounted on the electronic device; and
an endless band configured to be mounted on the sleeve.

2. A cover assembly as recited in claim 1, wherein the band comprises a bumper.

3. A cover assembly as recited in claim 1, wherein the band comprises a cosmetic band.

4. A cover assembly as recited in claim 1, wherein the band has a plurality of members thereon configured so as to enable a user of the handheld electronic device to wind a cord of the handheld device on the plurality of members.

5. A cover assembly as recited in claim 1, wherein the band has indicia thereon.

6. A cover assembly as recited in claim 1, wherein the band fits within a groove of the sleeve.

7. A cover assembly as recited in claim 1, wherein band fits substantially seamlessly within the sleeve.

8. A cover assembly as recited in claim 1, wherein an outer surface of the band is offset from the sleeve.

9. A cover assembly as recited in claim 1, wherein a thickness of the band exceeds a depth of a groove in the sleeve.

10. A cover assembly as recited in claim 1, wherein the band has a height that is greater than the adjacent portion of the sleeve.

11. A cover assembly as recited in claim 1, wherein the band has a width less than a width of the sleeve.

12. A cover assembly as recited in claim 1, wherein the band is substantially seamless with at least one of a front side or a back side of the sleeve.

13. A cover assembly as recited in claim 1, wherein the band includes one or more overhanging portions which partially cover at least one of a front side or a back side of the sleeve.

14. A cover assembly as recited in claim 13, wherein the one or more overhanging portions are squared.

15. A cover assembly as recited in claim 13, wherein the one or more overhanging portions are tapered.

16. A cover assembly as recited in claim 13, wherein the one or more overhanging portions are rounded.

17. A cover assembly as recited in claim 1, wherein the sleeve fits within a groove of the band.

18. A cover assembly as recited in claim 1, wherein the band is compressibly secured to the sleeve.

19. A cover assembly for use on a portable, handheld electronic device, comprising
a sleeve having apertures therein that correspond to portions of the portable electronic device; and
a band configured to be mounted on the sleeve.

20. A cover assembly as recited in claim 19, further comprising a cling configured to be mounted on the portable device.

21. A cover assembly as recited in claim 20, wherein the cling statically adheres to the portable device, beneath the sleeve.

22. A cover assembly as recited in claim 20, wherein the cling comprises at least one design portion corresponding to at least one of the portions of the portable electronic device.

23. A cover assembly as recited in claim 19, further comprising an accessory management system for storing one or more accessories usable with the portable electronic device.

24. A cover assembly as recited in claim 23, wherein the accessory management system is coupled to the band, the sleeve, or the electronic device.

25. A cover assembly as recited in claim 23, wherein the accessory management system maintains a cord in a stored position.

26. A cover assembly as recited in claim 19, wherein the sleeve further comprises a lanyard holder.

27. For use with a portable, handheld electronic device, a kit for an ornamental and protective cover assembly comprising:
a sleeve configured to be removably mounted to the handheld device; and
a band configured to be removably wrapped around at least a portion of the sleeve.

28. A kit as recited in claim 27, wherein the sleeve comprises a groove extending around the perimeter thereof, and wherein the band is configured to be at least partially received within the groove.

29. A kit as recited in claim 27, further comprising a cling for statically adhering to the handheld device.

30. A kit as recited in claim 27, further comprising a cord management system for storing an accessory cord.

31. A kit as recited in claim 27, wherein one or more apertures are formed on the sleeve for allowing access to accessories usable with the handheld device, and wherein the band is configured to allow access to the one or more apertures formed on the sleeve.
